(19) United States
(12) Patent Application Publication
(10) Pub. No.: US 2007/0258242 A1
(43) Pub. Date: Nov. 8, 2007

(54) Lamp having angle adjustable socket

(76) Inventor: Shih-Ming Lin, Shiushui Siang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/416,484

(22) Filed: May 2, 2006

(51) Int. Cl. F21V 21/30

(52) U.S. Cl. 362/250; 362/287; 362/405

(57) ABSTRACT

A lamp includes at least one decorative bar, and at least one socket angle adjustably mounted on the decorative bar. Thus, the socket is angle adjustable relative to the decorative bar to adjust the angle of the electric bulb on the socket so as to satisfy a user's requirement. In addition, the fixing flange of the insert of the socket has a shape and a size matching that of the fixing hole of the decorative bar, so that the fixing flange of the insert is fit into the fixing hole of the decorative bar easily and quickly, thereby facilitating the user adjusting the angle of the socket.

### BACKGROUND OF THE INVENTION

1. Field of the Invention

The present invention relates to a lamp and, more particularly, to a lamp having an angle adjustable socket.

2. Description of the Related Art

A conventional lamp comprises a plurality of decorative bars connected with each other, a plurality of sockets mounted on the respective decorative bar, and a plurality of electric bulbs mounted on the respective socket. However, each of the sockets is fixed on the respective decorative bar, so that the angle of each of the sockets is fixed and cannot be adjusted. Thus, the angle of each of the electric bulbs is fixed and cannot be adjusted to fit requirements of different users, thereby causing inconvenience to the user, and thereby limiting the versatility of the lamp.

### BRIEF SUMMARY OF THE INVENTION

In accordance with the present invention, there is provided a lamp, comprising at least one decorative bar, and at least one socket angle adjustably mounted on an end portion of the decorative bar.

The primary objective of the present invention is to provide a lamp having an angle adjustable socket.

Another objective of the present invention is to provide a lamp, wherein the angle between the socket and the decorative bar can be adjusted freely, so that the socket is angle adjustable relative to the decorative bar to adjust the angle of the electric bulb so as to satisfy a user's requirement, thereby enhancing the versatility of the lamp.

A further objective of the present invention is to provide a lamp, wherein the fixing flange of the insert is inserted into the fixing hole of the decorative bar by the restoring force of the elastic member after the angle adjustment between the socket and the decorative bar, so that the socket is attached to the decorative bar easily and quickly, thereby facilitating the user mounting the socket onto the decorative bar.

A further objective of the present invention is to provide a lamp, wherein the fixing flange of the insert has a shape and a size matching that of the fixing hole of the decorative bar, so that the fixing flange of the insert is fit into the fixing hole of the decorative bar easily and quickly, thereby facilitating the user adjusting the angle of the socket.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lamp in accordance with the preferred embodiment of the present invention.

FIG. 2 is a partially exploded perspective view of the lamp as shown in FIG. 1.

FIG. 3 is a partially plan cross-sectional view of the lamp as shown in FIG. 1.

FIG. 4 is a partially exploded perspective operational view of the lamp as shown in FIG. 1.

FIG. 5 is a schematic operational view of the lamp as shown in FIG. 1 in adjustment.

### DETAILED DESCRIPTION OF THE INVENTION

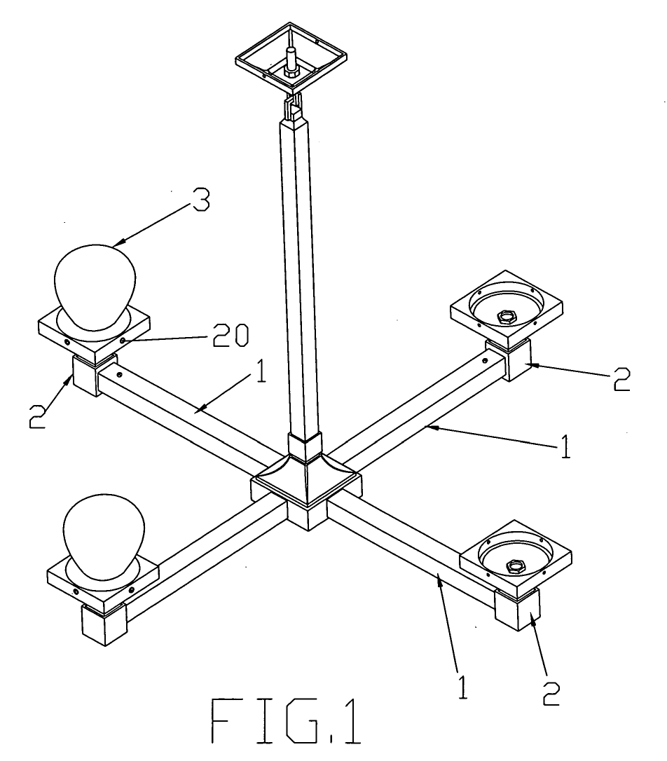

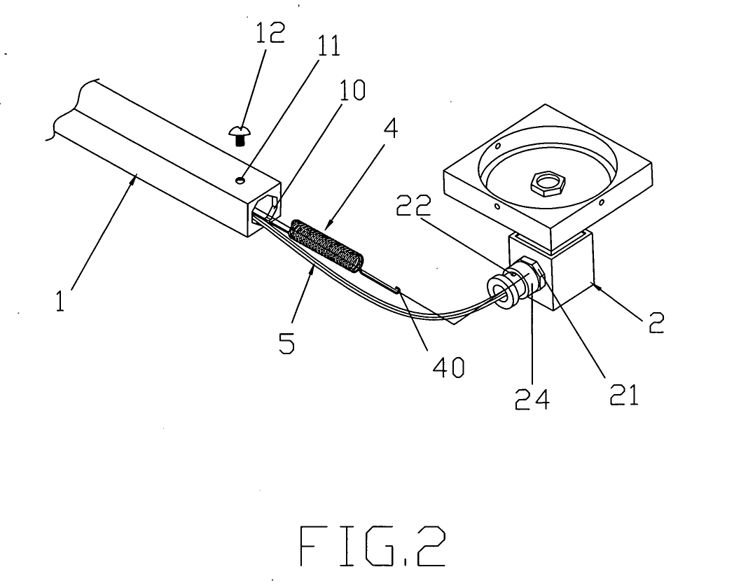

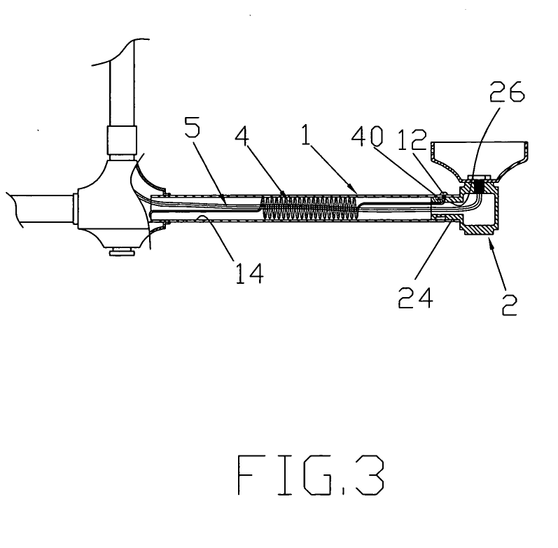

Referring to the drawings and initially to FIGS. 1-4, a lamp in accordance with the preferred embodiment of the present invention comprises at least one decorative bar 1, and at least one socket 2 angle adjustably mounted on an end portion of the decorative bar 1.

In the preferred embodiment of the present invention, the lamp comprises four decorative bars 1, and four sockets 2 each angle adjustably mounted on a respective one of the decorative bars 1.

The end portion of the decorative bar 1 has an end face formed with a fixing hole 10 connected to an inside 14 of the decorative bar 1 and has a peripheral wall formed with a screw bore 11. The fixing hole 10 of the decorative bar 1 is a polygonal hole whose sides have the same length.

The socket 2 has a side provided with an insert 24 inserted into the fixing hole 10 of the decorative bar 1. The insert 24 of the socket 2 has an end portion provided with a fixing flange 21 detachably secured in the fixing hole 10 of the decorative bar 1 and has a peripheral wall formed with a hook hole 22 connected to an inside 26 of the insert 24. The fixing flange 21 of the insert 24 is a polygonal flange whose sides have the same length. The fixing flange 21 of the insert 24 has a shape and a size matching that of the fixing hole 10 of the decorative bar 1, so that the fixing flange 21 of the insert 24 is closely fit into the fixing hole 10 of the decorative bar 1.

The lamp further comprises at least one electric bulb 3 mounted on the socket 2 by a plurality of screws 20, at least one locking screw 12 screwed into the screw bore 11 of the decorative bar 1 and having a distal end pressing an outer wall of the insert 24 of the socket 2 to lock the insert 24 of the socket 2 in the decorative bar 1, at least one elastic member 4 mounted in the decorative bar 1 and biased between the decorative bar 1 and the insert 24 of the socket 2 to provide a restoring force to the insert 24 of the socket 2, and at least one electric cord 5 extended through the inside 14 of the decorative bar 1, the elastic member 4 and the insert 24 of the socket 2 and electrically connected to the socket 2 to supply an electric power to the electric bulb 3. The elastic member 4 has a first end secured to an inner wall of the decorative bar 1 and a second end secured to the hook hole 22 of the insert 24.

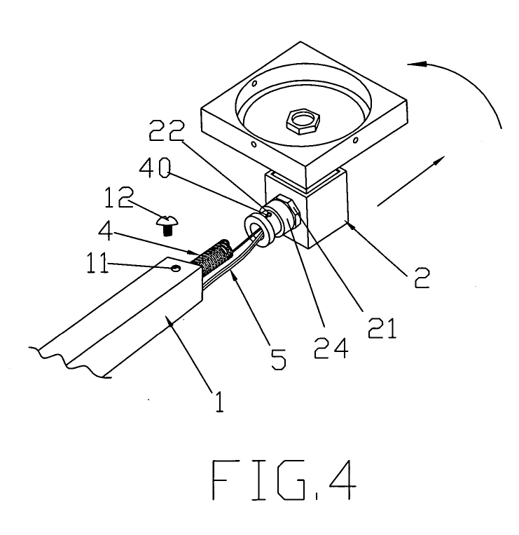

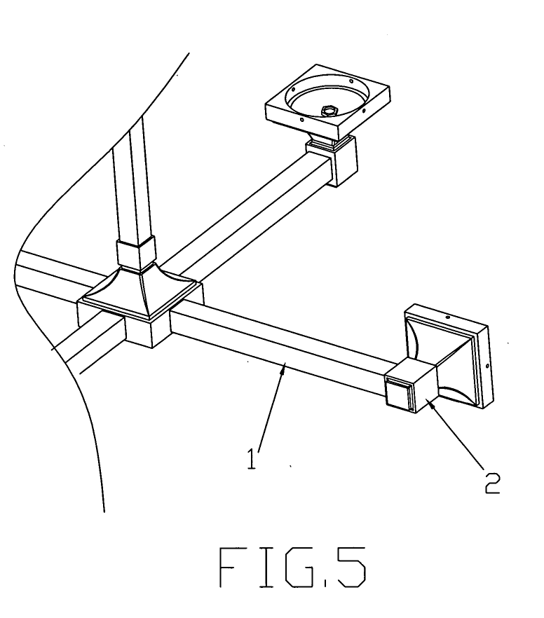

In operation, referring to FIGS. 4 and 5 with reference to FIGS. 1-3, after the locking screw 12 is rotated to detach from the insert 24 of the socket 2, the insert 24 of the socket 2 is unlocked from the decorative bar 1 and can be pulled outward to detach from the decorative bar 1. Then, the socket 2 is rotatable relative to the decorative bar 1 after the fixing flange 21 of the insert 24 is detached from the fixing hole 10 of the decorative bar 1 so as to change and adjust an angle between the socket 2 and the decorative bar 1. After adjustment of the angle between the socket 2 and the decorative bar 1 is finished, the fixing flange 21 of the insert 24 is inserted into the fixing hole 10 of the decorative bar 1 again by the restoring force of the elastic member 4 to attach the insert 24 of the socket 2 to the decorative bar 1. Then, the locking screw 12 is rotated to press the insert 24 of the socket 2 to lock the insert 24 of the socket 2 in the decorative bar 1 again, so that the socket 2 is secured to the decorative bar 1. Thus, the angle between the socket 2 and the decorative bar 1 can be adjusted freely as shown in FIGS. 1 and 5, so that the socket 2 is angle adjustable relative to the decorative bar 1 to adjust the angle of the electric bulb 3 so as to satisfy a user's requirement, thereby enhancing the versatility of the lamp.

Accordingly, the angle between the socket 2 and the decorative bar 1 can be adjusted freely, so that the socket 2 is angle adjustable relative to the decorative bar 1 to adjust the angle of the electric bulb 3 so as to satisfy a user's requirement, thereby enhancing the versatility of the lamp. In addition, the fixing flange 21 of the insert 24 is inserted into the fixing hole 10 of the decorative bar 1 by the restoring force of the elastic member 4 after the angle adjustment between the socket 2 and the decorative bar 1, so that the socket 2 is attached to the decorative bar 1 easily and quickly, thereby facilitating the user mounting the socket 2 onto the decorative bar 1. Further, the fixing flange 21 of the insert 24 has a shape and a size matching that of the fixing hole 10 of the decorative bar 1, so that the fixing flange 21 of the insert 24 is fit into the fixing hole 10 of the decorative bar 1 easily and quickly, thereby facilitating the user adjusting the angle of the socket 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp, comprising:
at least one decorative bar;
at least one socket angle adjustably mounted on an end portion of the decorative bar.

2. The lamp in accordance with claim 1, wherein the end portion of the decorative bar has an end face formed with a fixing hole connected to an inside of the decorative bar, the socket has a side provided with an insert inserted into the fixing hole of the decorative bar, and the insert of the socket has an end portion provided with a fixing flange detachably secured in the fixing hole of the decorative bar.

3. The lamp in accordance with claim 2, wherein the fixing hole of the decorative bar is a polygonal hole whose sides have the same length.

4. The lamp in accordance with claim 2, wherein the fixing flange of the insert is a polygonal flange whose sides have the same length.

5. The lamp in accordance with claim 2, wherein the fixing flange of the insert has a shape and a size matching that of the fixing hole of the decorative bar, so that the fixing flange of the insert is closely fit into the fixing hole of the decorative bar.

6. The lamp in accordance with claim 2, further comprising at least one elastic member mounted in the decorative bar and biased between the decorative bar and the insert of the socket to provide a restoring force to the insert of the socket.

7. The lamp in accordance with claim 6, wherein the insert of the socket has a peripheral wall formed with a hook hole connected to an inside of the insert, and the elastic member has a first end secured to an inner wall of the decorative bar and a second end secured to the hook hole of the insert.

8. The lamp in accordance with claim 6, further comprising at least one electric cord extended through the inside of the decorative bar, the elastic member and the insert of the socket and electrically connected to the socket.

9. The lamp in accordance with claim 2, wherein the end portion of the decorative bar has a peripheral wall formed with a screw bore, and the lamp further comprises at least one locking screw screwed into the screw bore of the decorative bar and having a distal end pressing an outer wall of the insert of the socket to lock the insert of the socket in the decorative bar.

10. The lamp in accordance with claim 1, further comprising at least one electric bulb mounted on the socket by a plurality of screws.

11. The lamp in accordance with claim 2, wherein the socket is rotatable relative to the decorative bar after the fixing flange of the insert is detached from the fixing hole of the decorative bar so as to change and adjust an angle between the socket and the decorative bar.

12. The lamp in accordance with claim 6, wherein the fixing flange of the insert is inserted into the fixing hole of the decorative bar by the restoring force of the elastic member to attach the insert of the socket to the decorative bar.

13. The lamp in accordance with claim 6, wherein the fixing flange of the insert is inserted into the fixing hole of the decorative bar by the restoring force of the elastic member after an angle adjustment between the socket and the decorative bar, so that the socket is attached to the decorative bar.
